(19) United States
(12) Patent Application Publication
(10) Pub. No.: US 2003/0122994 A1
(43) Pub. Date: Jul. 3, 2003

(54) Liquid crystal display with a changeable front frame

(76) Inventors: Yeong Kuen Chen, Tainan Hsien (TW); Bo-Xun Wu, Tainan (TW)

Correspondence Address: RABIN & CHAMPAGNE, PC, 1101 14TH STREET, NW, SUITE 500, WASHINGTON, DC, 20005, US

(21) Appl. No.: 10/241,443

(22) Filed: Sep. 12, 2002

(30) Foreign Application Priority Data
Dec. 28, 2001 (TW) 090223612

(51) Int. Cl. G02F 1/1333

(52) U.S. Cl. 349/58

(57) ABSTRACT

A liquid crystal display with a changeable front frame. The liquid crystal display comprises a rear frame, a liquid crystal panel module, and a front frame. The rear frame includes a concave portion and a first engaging member. The liquid crystal panel module, including a pinhole, is disposed on the rear frame. The front frame, including a second engaging member and a pin, is disposed in the concave portion of the rear frame in a changeable manner. The second engaging member is engaged with the first engaging member, and the pin is inserted into the pinhole. Thus, the front frame is positioned relative to the liquid crystal panel module.

### BACKGROUND OF THE INVENTION

1. Field of the Invention

The invention relates to a liquid crystal display; in particular, a liquid crystal display with a changeable front frame.

2. Description of the Related Art

Normally, a liquid crystal display mainly comprises a front frame, a rear frame, and a liquid crystal panel module. FIG. 1 shows a conventional liquid crystal display. During assembly of the conventional liquid crystal display, the un-illustrated liquid crystal panel module is firstly mounted on a front frame 12. Then, the front frame 12 is combined with a rear frame 11 by hooks 121 on the front frame 12 engaging with protrusions 111 on the rear frame 11.

In the conventional liquid crystal display, since the liquid crystal panel module is mounted on a front frame, the front frame cannot be easily changed based on different requirements, such as colors or types.

Specifically, since the front frame receives the liquid crystal panel module, the structure of the front frame is restrained by the structure of the rear frame. That is, the front frame must correspond to the rear frame in many ways. As a result, the front frame cannot be easily changed due to the limitation of the rear frame.

### SUMMARY OF THE INVENTION

In order to address the disadvantages of the aforementioned liquid crystal display, the invention provides a liquid crystal display with a changeable front frame.

Accordingly, the invention provides a liquid crystal display. The liquid crystal display comprises a rear frame, a liquid crystal panel module, and a front frame. The rear frame includes a concave portion and a first engaging member. The liquid crystal panel module, including a pinhole, is disposed on the rear frame. The front frame, including a second engaging member and a pin, is disposed in the concave portion of the rear frame in a changeable manner. The second engaging member is engaged with the first engaging member, and the pin is inserted into the pinhole. Thus, the front frame is positioned relative to the liquid crystal panel module.

In a preferred embodiment, the liquid crystal display further comprises at least one first screw connecting the rear frame and the liquid crystal panel module.

Furthermore, the liquid crystal panel module includes at least one first through hole, and the rear frame includes at least one first threaded post corresponding to the first through hole. Thus, the liquid crystal panel module is mounted on the rear frame by the first screw into the first threaded post through the first through hole.

It is understood that the first engaging member includes a receiving portion while the second engaging member includes a hook.

In another embodiment, the front frame includes a plurality of second through holes, and a plurality of buttons disposed in the second through holes respectively.

In another embodiment, the liquid crystal display further comprises at least one second screw connecting the rear frame and the front frame.

Furthermore, the rear frame includes at least one third through hole, and the front frame includes at least one second threaded post corresponding to the third through hole. Thus, the front frame is mounted on the rear frame by the second screw into the second threaded post through the third through hole.

In another embodiment, the rear frame includes a support supporting the front frame disposed in the concave portion of the rear frame.

### BRIEF DESCRIPTION OF THE DRAWINGS

The invention is hereinafter described in detail with reference to the accompanying drawings in which:

FIG. 1 is a schematic view of a conventional liquid crystal display;

FIG. 2a is an exploded view of a liquid crystal display as disclosed in the invention;

FIG. 2b is an enlarged view of a part B in FIG. 2a;

FIG. 2c is another exploded view of a liquid crystal display as disclosed in the invention, wherein a liquid crystal panel module is mounted on a rear frame;

FIG. 2d is a schematic view of the assembled liquid crystal display in FIG. 2a;

FIG. 3a is another exploded view of a liquid crystal display as disclosed in the invention, wherein the liquid crystal panel module is omitted;

FIG. 3b is an enlarged view of a part A in FIG. 3a; and

FIG. 3c is an enlarged view of a part C in FIG. 3a.

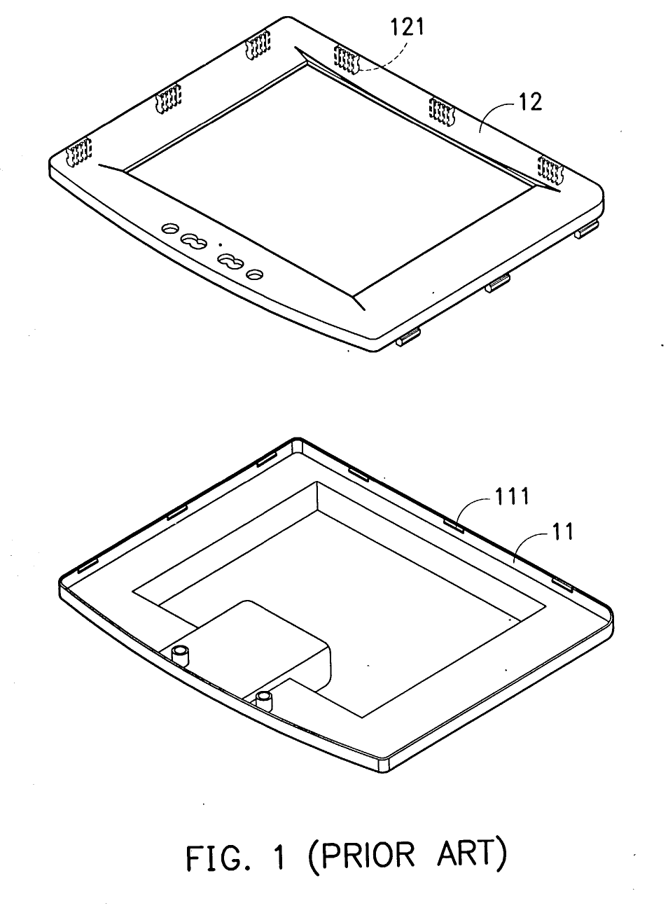

### DETAILED DESCRIPTION OF THE INVENTION

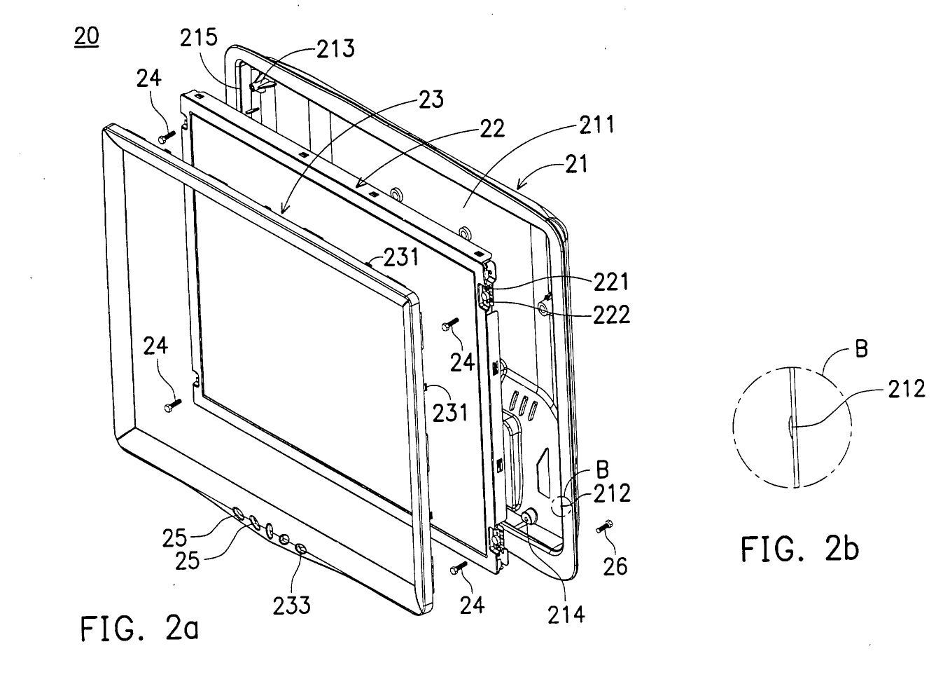

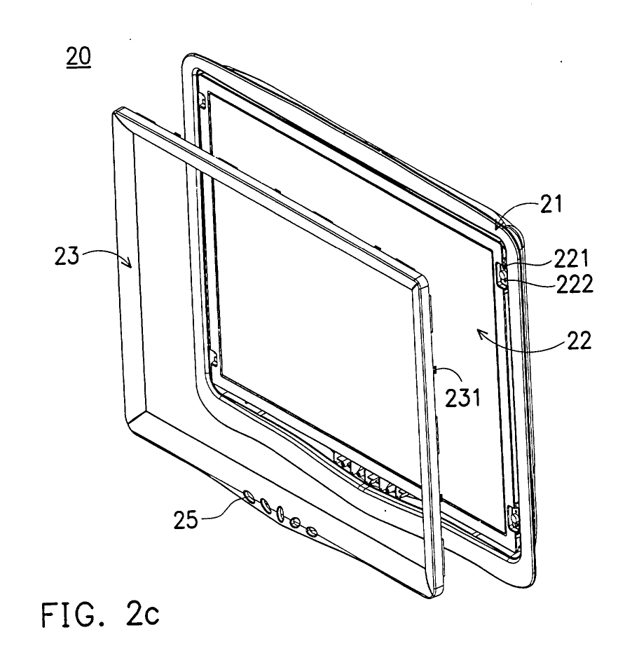

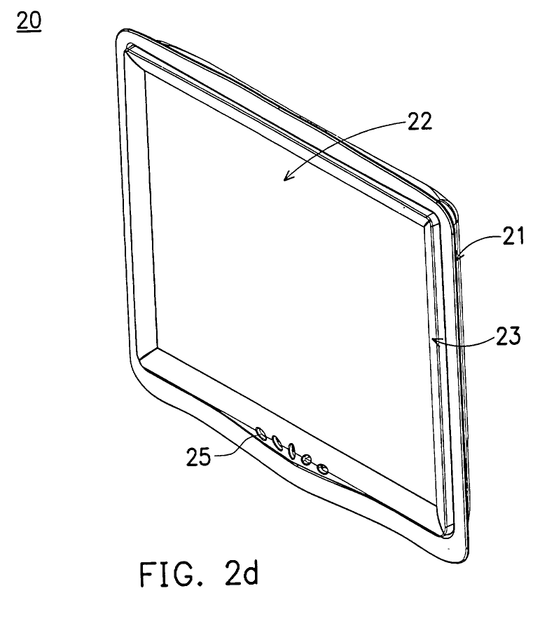

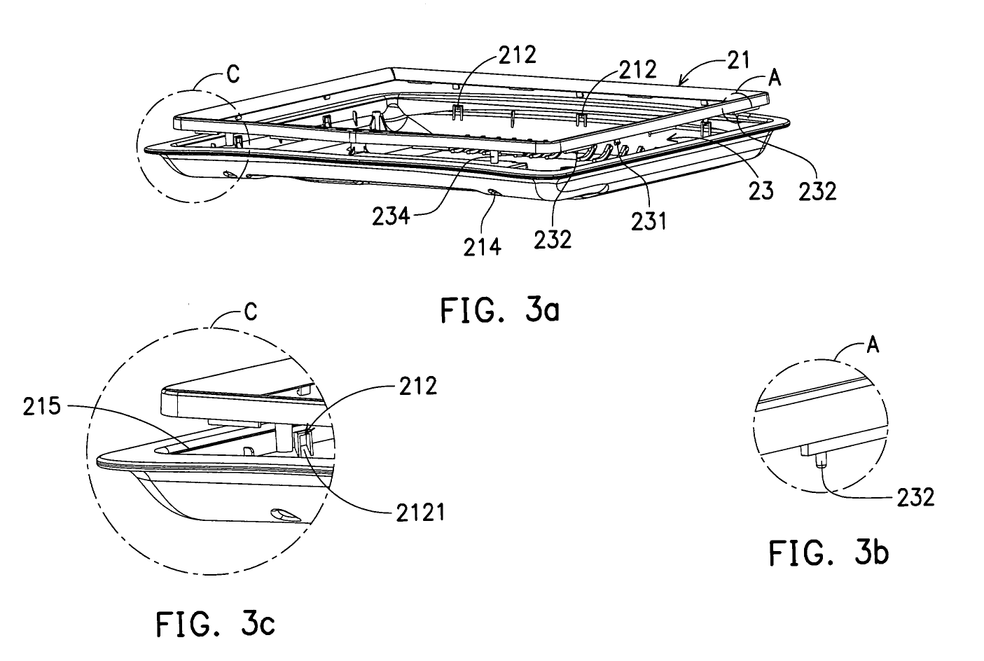

Referring to FIG. 2a, FIG. 2b, FIG. 2c, FIG. 2d, FIG. 3a, FIG. 3b and FIG. 3c, a liquid crystal display 20 as disclosed in the invention comprises a rear frame 21, a liquid crystal panel module 22, a plurality of front frames 23, a plurality of first screws 24, a plurality of buttons 25, and a plurality of second screws 26. It is noted that only one front frame 23 is shown in figures.

The rear frame 21 includes a concave portion 211 receiving the liquid crystal panel module 22. The rear frame 21 further includes a plurality of first engaging members 212, a plurality of first threaded posts 213, a plurality of third through holes 214, and a support 215 around the concave portion 211.

As shown in FIG. 3c, each of the first engaging members 212 includes a receiving portion 2121 engaging the front frame 23. It is understood that the number of first engaging members 212 is not limited to two or three as shown as long as the rear frame 21 can engage with the front frame 23.

Each of the first threaded posts 213 is formed on a predetermined position of the rear frame 21, and receives the first screw 24. Each of the third through holes 214 is formed on a predetermined position of the rear frame 21, for the second screw 26 to pass through. As shown in FIG. 2a and FIG. 3c, the support 215 supports the front frame 23 disposed in the concave portion 211 of the rear frame 21 to prevent the front frame 23 from deforming due to abnormal force.

The liquid crystal panel module 22 is used as a display unit for the liquid crystal display 20, and includes a plurality of pinholes 221 and a plurality of first through holes 222 corresponding to the first threaded posts 213. The liquid crystal panel module 22 is mounted on the rear frame 21 by the first screws 24 into the first threaded posts 213 of the rear frame 21 through the first through holes 222 of the liquid crystal panel module 22.

Each of the front frames 23 includes a plurality of second engaging members 231, a plurality of pins 232, a plurality of second through holes 233, and a plurality of second threaded posts 234.

Each of the second engaging members 231 corresponds to the first engaging member 212 of the rear frame 21 respectively, and may be formed as a hook. It is understood that the number of second engaging members 231 is not limited to two or three as shown as long as the rear frame 21 can engage with the front frame 23.

As shown in FIG. 3a and FIG. 3b, each of the pins 232 corresponds to the pinholes 221 of the liquid crystal panel module 22 to pass through the pinhole 221 respectively, and is formed on a predetermined position of the front frame 23.

The second through holes 233 receive the buttons 25. It is understood that the buttons 25 maybe fixed on the front frame 23 to form an integrally formed unit.

Each of the second threaded posts 234 is formed on a predetermined position of the front frame 23, for the second screw 26.

The front frame 23 is disposed in the concave portion 211 of the rear frame 21 in a changeable manner. To dispose the front frame 23 on the rear frame 21, the second engaging members 231 of the front frame 23 are firstly engaged with the first engaging members 212 of the rear frame 21 so that the front frame 23 is combined with the rear frame 21. At the same time, the pins 232 of the front frame 23 are inserted into the pinholes 221 of the liquid crystal panel module 22 so that the front frame 23 is properly positioned relative to the liquid crystal panel module 22. Then, the second screws 26 are screwed to the second threaded posts 234 of the front frame 23 through the third through holes 214 of the rear frame 21 so that the front frame 23 is fixedly mounted on the rear frame 21.

As stated above, since the front frame includes the first engaging members corresponding to the second engaging members of the rear frame, and the pins corresponding to the pinholes of the liquid crystal panel module, the front frame can be easily fixed on the rear frame. That is, in the liquid crystal display as disclosed in the invention, the front frame is easily changed.

Furthermore, since the liquid crystal panel module is combined with the rear frame, the front frame is not responsible for holding the liquid crystal panel module. Thus, the flexibility of the front frame is increased.

In addition, since the front frame is disposed in the concave portion of the rear frame, the area of the front frame is smaller than that of the rear frame. Also, the front frame is not responsible for holding the liquid crystal panel module. Thus, the front frame can be changed based on different conditions.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A liquid crystal display comprising:
a rear frame including a concave portion and a first engaging member;
a liquid crystal panel module, including a pinhole, disposed on the rear frame; and
a front frame, including a second engaging member and a pin, disposed in the concave portion of the rear frame in a changeable manner, wherein the second engaging member is engaged with the first engaging member and the pin is inserted into the pinhole so that the front frame is positioned relative to the liquid crystal panel module.

2. The liquid crystal display as claimed in claim 1, further comprising:
at least one first screw connecting the rear frame and the liquid crystal panel module.

3. The liquid crystal display as claimed in claim 2, wherein the liquid crystal panel module includes at least one first through hole, and the rear frame includes at least one first threaded post corresponding to the first through hole, whereby the liquid crystal panel module is mounted on the rear frame by the first screw into the first threaded post through the first through hole.

4. The liquid crystal display as claimed in claim 1, wherein the first engaging member includes a receiving portion.

5. The liquid crystal display as claimed in claim 1, wherein the second engaging member includes a hook.

6. The liquid crystal display as claimed in claim 1, wherein the front frame includes a plurality of second through holes, and a plurality of buttons disposed in the second through holes respectively.

7. The liquid crystal display as claimed in claim 1, further comprising:
at least one second screw connecting the rear frame and the front frame.

8. The liquid crystal display as claimed in claim 7, wherein the rear frame includes at least one third through hole, and the front frame includes at least one second threaded post corresponding to the third through hole, whereby the front frame is mounted on the rear frame by the second screw into the second threaded post through the third through hole.

9. The liquid crystal display as claimed in claim 1, wherein the rear frame includes a support supporting the front frame disposed in the concave portion of the rear frame.

10. A liquid crystal display comprising:
a rear frame;
a liquid crystal panel module disposed on the rear frame; and
a front frame disposed in the rear frame in a changeable manner.

11. The liquid crystal display as claimed in claim 10, further comprising:
at least one first screw connecting the rear frame and the liquid crystal panel module.

12. The liquid crystal display as claimed in claim 11, wherein the liquid crystal panel module includes at least one first through hole, and the rear frame includes at least one first threaded post corresponding to the first through hole, whereby the liquid crystal panel module is mounted on the rear frame by the first screw into the first threaded post through the first through hole.

13. The liquid crystal display as claimed in claim 10, wherein the rear frame includes at least one first engaging member, and the front frame includes at least one second engaging member corresponding to the first engaging member, whereby the front frame is mounted on the rear frame by the first engaging member engaging with the second engaging member.

14. The liquid crystal display as claimed in claim 13, wherein the first engaging member includes a receiving portion.

15. The liquid crystal display as claimed in claim 13, wherein the second engaging member includes a hook.

16. The liquid crystal display as claimed in claim 10, wherein the liquid crystal panel module includes at least one pin, and the front frame includes at least one pinhole corresponding to the pin, whereby the front frame is positioned relative to the liquid crystal panel module by the pin inserting into the pinhole.

17. The liquid crystal display as claimed in claim 10, wherein the front frame includes a plurality of second through holes, and a plurality of buttons disposed in the second through holes respectively.

18. The liquid crystal display as claimed in claim 10, further comprising:
at least one second screw connecting the rear frame and the front frame.

19. The liquid crystal display as claimed in claim 18, wherein the rear frame includes at least one third through hole, and the front frame includes at least one second threaded post corresponding to the third through hole, whereby the front frame is mounted on the rear frame by the second screw into the second threaded post through the third through hole.

20. The liquid crystal display as claimed in claim 10, wherein the rear frame includes a support supporting the front frame disposed in the concave portion of the rear frame.
